(19) United States
(12) Patent Application Publication
(10) Pub. No.: US 2018/0108265 A1
(43) Pub. Date: Apr. 19, 2018

(54) STUDENT PROGRESS SYSTEM

(71) Applicant: Huntington Mark, LLC, Oradell, NJ (US)

(72) Inventors: Raymond J. Huntington, Juno Beach, FL (US); Beverly Collins, Haworth, NJ (US); Frank Frontignano, Jersey City, NJ (US); Benjamin Blake, Montville, NJ (US); Carol Lovallo, Old Bridge, NJ (US)

(21) Appl. No.: 15/295,345

(22) Filed: Oct. 17, 2016

(51) Int. Cl. G09B 5/12; G06F 17/30

(52) U.S. Cl. CPC G09B 5/12; G06F 17/30943

(57) ABSTRACT

Aspects of the disclosure relate to generating and monitoring one or more student programs. For example, one or more processors may load education data corresponding to one or more students. The one or more processors may generate, for each student, a generated student program and identify one or more generated student programs which fail to satisfy at least one or more rules. The one or more generated student programs which fail to satisfy the at least one or more rules may be automatically reported, by the one or more processors.

### BACKGROUND

Lesson plans, such as those used by tutoring centers, typically follow stringent pre-programmed formats which are created for use by large groups of students. Such lesson plans may result in students being provided with lessons on topics outside of their abilities or with lessons on topics which the students do not need reinforcement. As such, students may waste time learning about topics in which they are already proficient, or become frustrated by lessons for which they do not have the requisite background to understand. Further, the cost incurred by the students may be inflated, as the lessons may be unnecessary and ineffective at teaching the topics and material which the student needs to learn.

Educators, such as teachers and tutors, may create individualized lesson plans for each student based on the educator's own teaching experience and knowledge. However, the educator's experiences and knowledge may be based on ineffective training or outdated material. Since educators only have their own knowledge and experience from which to cull material and teaching techniques, educators may not be able to respond to each individual student's learning style or to provide the most effective teaching techniques and lessons. As such, students may not respond to the educator's teaching style and may not learn lesson topics and material as efficiently as possible.

As such, there is a need for systems, methods, and apparatuses which provide educators with the tools necessary to provide the most efficient and effective lesson plans and teaching material possible. There is also a need for allowing educators to adjust lesson plans when they notice a student is struggling with the lesson being taught or excelling beyond the material in the lesson. In addition, there is a need to enable educators to be able to use proven teaching techniques to educate students with material that is relevant and effective.

### BRIEF SUMMARY

Embodiments within the disclosure generally relate to the creation and management of personalized student programs by a tutoring center, tutor, teacher, or other such educators. One aspect includes a method for generating and monitoring one or more student programs. One or more processors may load education data corresponding to one or more students. For each student the one or more processors may generate a generated student program. The one or more processors may identify one or more generated student programs which fail to satisfy at least one or more rules and automatically report the one or more generated student programs which fail to satisfy the at least one or more rules.

In some embodiments the one or more processors may, for each student, track the student's progress through the respective generated student program, identify the one or more generated student programs which fail to satisfy the at least one or more rules based on the student's progress, and automatically report the one or more generated student programs which fail to satisfy the at least one or more rules based on the student's progress.’

In some embodiments, for each of the one or more generated student programs which fail to satisfy the at least one or more rules, the generated student program may be updated. Each updated student program may be determined to satisfy all of the one or more rules and the updated student programs may be published.

In some embodiments, for each student, the generated student program may be published.

In some embodiments, identifying the one or more generated student programs which fail to satisfy the at least one or more rules occurs at a predetermined time period.

In some embodiments, automatically reporting the one or more generated student programs which fail to satisfy the at least one or more rules comprises providing a visual notification to a display.

Another aspect includes a system for generating and monitoring one or more student programs. The system may include one or more computing devices and memory storing instructions, the instructions executable by the one or more computing devices. The instructions may include loading education data corresponding to one or more students; generating, for each student, a generated student program; identifying one or more generated student programs which fail to satisfy at least one or more rules; and automatically reporting the one or more generated student programs which fail to satisfy the at least one or more rules.

Another aspect includes a non-transitory computer-readable medium storing instructions. The instructions, when executed by one or more processors, cause the one or more processors to perform the steps of: loading education data corresponding to one or more students; generating, for each student, a generated student program; identifying one or more generated student programs which fail to satisfy at least one or more rules; and automatically reporting the one or more generated student programs which fail to satisfy the at least one or more rules.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is a flow diagram of a process for generating a student program for a new student in accordance with embodiments of the disclosure.

FIG. 4 is an illustration of an interface for generating a student program for a new student in accordance with aspects of the disclosure.

FIG. 5 is a flow diagram of a process for adjusting a student program in accordance with embodiments of the disclosure.

FIG. 6 is an illustration of a reprogramming interface in accordance with aspects of the disclosure.

FIG. 7 is a flow diagram of a process for monitoring student programs in accordance with embodiments of the disclosure.

FIG. 8 is an illustration of an alert interface in accordance with aspects of the disclosure.

### DETAILED DESCRIPTION

### Overview

The technology of this disclosure relates to, by way of example, the creation and management of personalized student programs (i.e., lesson plans) by a tutoring center, tutor, teacher, or other such educators (“educator(s)”). For instance, a student may seek tutoring or other such instruction (“education services”) from an educator. During an evaluation period, the student may perform tasks and take tests to provide the educator with a baseline of the student's knowledge and abilities. Based on the results of the evaluation a tracking program may generate a student program outlining a lesson plan designed for the student based on the student's knowledge and abilities, as well as conforming to preprogrammed guidelines. The educator may then analyze the generated student program and adjust the student program as deemed necessary, but within the preprogrammed guidelines.

The generated student program may be broken up into individual lesson sessions which may be completed by the student during a single instruction session with the educator. As the student completes lessons during a lesson session, a tracking program may request the student to answer questions and/or take a test. The educator may track the student's progress throughout the lesson session by entering results of the questions and the test into the tracking program. Based on the student's progress the tracking program may update the student's program in real-time. As such, the student may be instructed to repeat lessons, be provided with different materials which provide the same lessons, or skip ahead to different lessons while in a lesson session.

At the completion of a lesson session, the educator may enter notes and/or comments regarding the student or the generated student program into the tracking program. In this regard, the educator may be automatically prompted to answer one or more questions and/or enter notes which are specific to the student and lessons which were covered during the lesson session.

The tracking program may analyze each generated student program for compliance with a set of rules at preset intervals. In this regard, the tracking program may process each generated student program against a plurality of rules to determine whether the generated student program complies with the rules. Based on the results of the rules the program may adjust the student program, such as by adding or removing lessons and/or materials.

The features described above may allow for educators to provide their students with the most efficient and effective lessons and materials. In addition, educators may more easily track their student's progress through the materials, while still maintaining control to adjust the lessons and materials as necessary.

As discussed in detail below, the features described herein allow for various alternatives.

### Example Systems

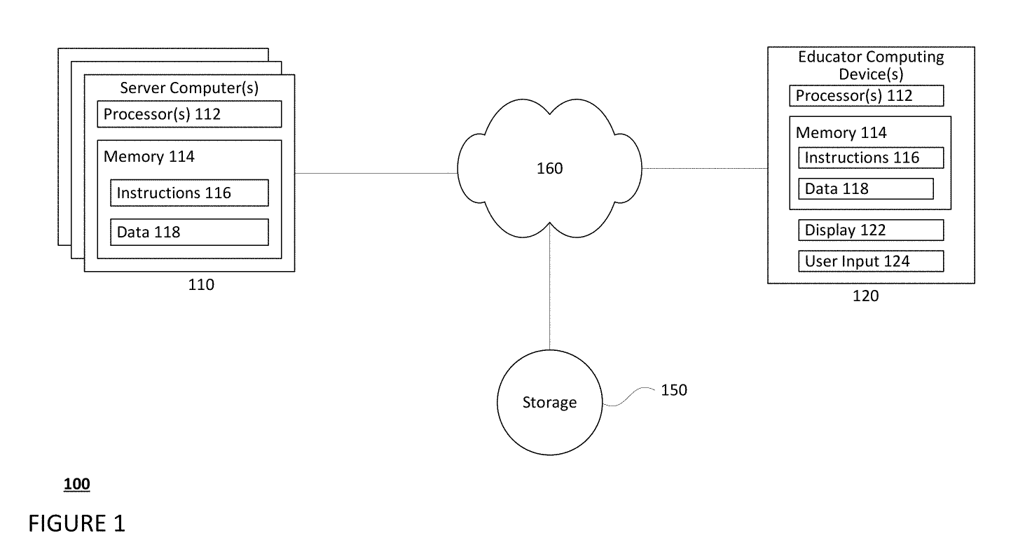

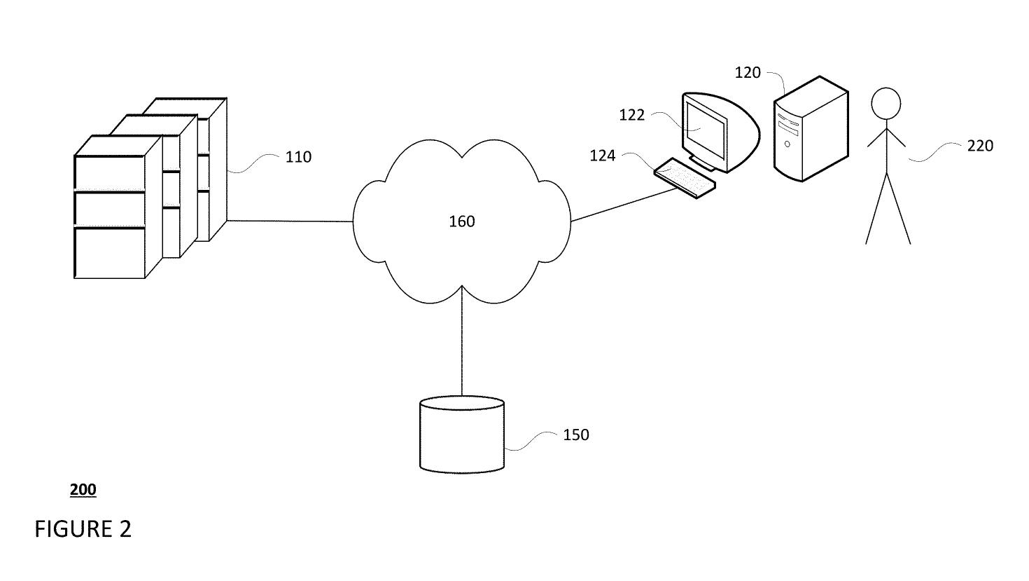

An example system 100, as shown in FIGS. 1 and 2 may implement the features described herein. It should not be considered as limiting the scope of the disclosure or usefulness of the features described herein. In this example, system 100 may include server computers 110 and educator computing device(s) 120 (the “computing devices”), as well as storage system 150. Each computing device 110-120 may contain one or more processors 112, one or more memory modules 114, and other components commonly found in general and special purpose computing devices, such as displays 122 and user input devices 124.

Memory 114 of each of computing devices 110 and 120 may store information accessible and executable by the one or more processors 112, including instructions 116, such as programs and operating systems. Memory may also store, adjust, and retrieve data 118. Such data 118 may be used to execute the instructions 116 and/or for performing other functions. The memory may be of any non-transitory type capable of storing information accessible by the processor, such as a hard-drive, solid state hard-drive, memory card, ROM, RAM, DVD, CD-ROM, write-capable, read-only memories, and other such non-transitory types of memory.

The instructions 116 may be any computer code which may be executed directly or indirectly by the one or more processors. The instructions may be stored as lines of codes or as entire programs, such as the programs described herein. Further, the instructions 116 may be in a format which may be read and executed by the processor. In some embodiments the instructions may be stored in a location separate from the computing device, such as in a remote network storage drive, such as storage device 150. The terms “instructions,” “application,” and “programs” may be used interchangeably herein. Data 118 may be read and executed by the one or more processors 112 in accordance with the instructions 116.

Data 118 may be retrieved, stored or modified by the one or more processors 112 in accordance with the instructions 116. For instance, although the subject matter described herein may be of any data structure commonly used to store data, such as relational databases, non-relational databases, SQL databases, and other such tables or documents. Additionally, the data 118 may be stored in fields and formats readable by the processor 112, such as in a table having many different fields and records, XLS, TXT, or XML documents. The data 118 may also be stored in machine code or assembly language. Moreover, the data may be associated with information which identifies other relevant information, such as other data and references to the other data, which may be stored in the same memory as the data 118 or in other memories at the same or different locations as the data 118.

The one or more processors 112 may be any conventional processors, such as commercially available CPUs from Intel, AMD, or Apple. Alternatively, the processors may be dedicated components such as an application specific integrated circuit (“ASIC”) or other hardware-based processors, such as ARM processors or System on Chips (SoCs). Alternatively, the processors may be dedicated components such as an application specific integrated circuit (“ASIC”) or other hardware-based processor.

Although FIG. 1 functionally illustrates the components of the computing devices 110 and 120 as being single components (i.e., processor, memory, etc.,) the components may be comprised of more than one. The components may or may not be stored within the same physical housing. For example, the processors may be distributed processors located in housings different from that of the computing devices 110. Accordingly, references to a processor, computer, computing device, or memory will be understood to include references to a collection of processors, computers, computing devices, or memories that may or may not operate in parallel. Further, although some instructions are described below as occurring on a single computing device at a point in time, various aspects of the subject matter described herein may be implemented by a plurality of computing devices in series or in parallel over a period of time.

Storage device 150 may be of any type of storage capable of storing information accessible by the server computing devices 110, member computing device 120, or retail computing device 140, such as a hard-drive, a solid state hard drive, NAND memory, ROM, RAM, DVD, CD-ROM, write-capable, and read-only memories. In addition, storage device 150 may include a distributed storage device where data is stored on a plurality of different storage devices which may be physically located at the same or different geographic locations, such as network attached storage. Storage device 150 may be connected to the computing devices via the network 160 as shown in FIG. 1, and/or may be directly connected to any of the computing devices 110 and 120.

The network 160 and intervening nodes, described herein, may be interconnected using various protocols and systems. For example, the network 160 may be implemented via the Internet, intranets, local area networks (LAN), wide area networks (WAN), etc. Communication protocols such as Ethernet, WiFi, and HTTP, Bluetooth, LTE, 3G, 4G, Edge, etc., and various combinations of the foregoing may be used to allow the nodes to communicate.

Each of the computing devices 110 and 120 may communicate over the network 160. In this regard, each of the computing devices 110 and 120, as well as storage device 150, may be at different nodes of a network 160 and capable of directly and indirectly communicating with other nodes of network 160. As an example, each of the computing devices 110 and 120 may be capable of communicating with storage system 150 via the network. In another example, one or more of server computing devices 110 may use network 160 to transmit and present information to a user, such as educator 220 on a display, such as display 122 of computing device 120.

Although only a few computing devices are depicted in FIGS. 1-2, it should be appreciated that a typical system may include a large number of connected computing devices 110 and 120. For example, each educator, of which there may be an indefinite number, may have at least one educator computing device 120. As a further example, each of the server computer(s) 110 may include web servers, operating at different nodes on the network 160, capable of communicating with storage system 150 as well as with computing devices 120 via the network.

Computing devices 110 and 120 may be a personal computing device and have all of the components normally used in connection with a personal computing device having a processor 112 such as a central processing unit (CPU), memory 114, such as a hard drive storing data 118 and instructions 116, a display such as display 122, (e.g., a monitor having a screen, a touch-screen, a projector, a television, or other device that is operable to display information), and user input device 124 (e.g., a mouse, keyboard, touch screen, or microphone). Although not shown, server computing devices 110 may also include displays and user input devices. The computing devices 110 and 120 may also include a camera for recording video streams and/or capturing images, speakers, a network interface device, and all of the components used for connecting these elements to one another.

Although educator computing device 120 may comprise a full-sized personal computing device, educator computing device 120 may alternatively comprise mobile computing devices capable of wirelessly exchanging data with a server over a network such as the Internet. By way of example only, educator computing device 120, although depicted as a personal computing device, may be a mobile phone or a device such as a wireless-enabled PDA, a tablet PC, or a netbook that is capable of obtaining information via the Internet.

The educator computing device 120 may be configured to provide specific functions in accordance with embodiments of the technology. In this regard, the educator provider computing device 120 may be programmed to communicate with server computing device 110 and storage device 150 to receive and upload education data, such as student records, generated student programs, notes and/or comments regarding students, educator schedules, and other such data discussed herein. In some embodiments the educator computing device 120 may store and retrieve education data locally.

The educator computing device 120 may be programmed to run one or more programs, such as the tracking program, to perform the functions described in detailed herein. For example, the educator computer device 120 may be programmed to allow educators, such as educator 220, to generate, track, and update student programs, as well as guide each student through the student's respective generated student program. In this regard, the educator computing device 120 may be programmed to provide educators with the ability to view one or more generated student programs, as described further herein. In addition, the educator computing device 120 may provide the educators with a schedule of student's upcoming lesson sessions which they are assigned to teach, as well as the ability to view adjust, and reschedule one or more lesson sessions.

The educator computing device 120 may be further programmed to alert the educators of the current progress of one or more students, changes to one or more student's lesson plans, comments regarding a student, and other such relevant information. For example, upon a student beginning a lesson session, the educator computing device may inform the educator where the student previously left off during a prior lesson session as well inform the educator why the student was unable to complete the prior lesson session. In addition, the educator computing device may alert the educator of which lesson the student should undertake next

As a student progresses through a lesson session, the educator computer device may be programmed to update the student's records and progress including updating the education data to include completion information such as scores entered by the educator at the end of a lesson. Based on the education data input into by the educator, the educator computing device 120 may update the student's generated student plan and adjust lesson sessions in real time. In this regard, the educator computer device may communicate with the server computer 110 to provide for analysis, by the server computer 110, of the education data input by the educator to determine whether the student's current lesson session or generated student plan needs to be adjusted, as further described herein. In some embodiments the educator computer device may analyze the education data input by the educator without the assistance of the server computer 110.

Educators, or other individuals or companies, may operate one or more central servers which maintain the education data. In this regard, the central server, such as server computers 110, may maintain one or more storage devices which store some or all of the education data in a database. In some embodiments, one or more of the functions of the central servers may be implemented by educator computing devices 120. As such, the educators may operate the educator computing devices 120 which perform the functions of the server computer in place of, or in concert with the educator's central server.

The central server may store, retrieve, and manipulate the education data. As previously described, the education data may include the data of each educator and student. Educator data may include data common to the education of a student, such as data found in Table 1, below. Each type of education data may be stored in association with the educator, tutoring center, and educators with which the education data is related. In this regard, the data in Table 1 is separated into columns representing the education data which may be associated with students, educators, and tutoring centers, respectively.

TABLE 1

| Student | Educator | Tutoring Center |
|---|---|---|
| Biographical Information | Biographical Information | Location Information (e.g., |
| (e.g., name, age, grade, etc.) | (e.g., name, place of | name, address, etc.) |
| | employment, etc.) | |
| Notes and Comments | Assigned Students | Employed Educators |
| Generated Lesson Plan and | Schedule | Registered Students |
| Progress | | |
| Materials Assigned | | Materials Available |
| Test and Question Scores | | Program Requirements (i.e., |
| | | rules) |
| Lesson Sessions and Progress | | |

In some embodiments more than one educator may have access to the education data on computing device 120 and server computers 110. As such, more than one educator may perform the functions described herein. For example, a tutoring center may employ a number of tutors, as well as administrative staff. The tutoring center may assign groups of students to each tutor. The tutors may be provided access to education data corresponding to only their respective group of students. In some embodiments the tutors may be able to access all education data. Further, administrative staff may be provided access to some or all of the education data.

### Example Methods

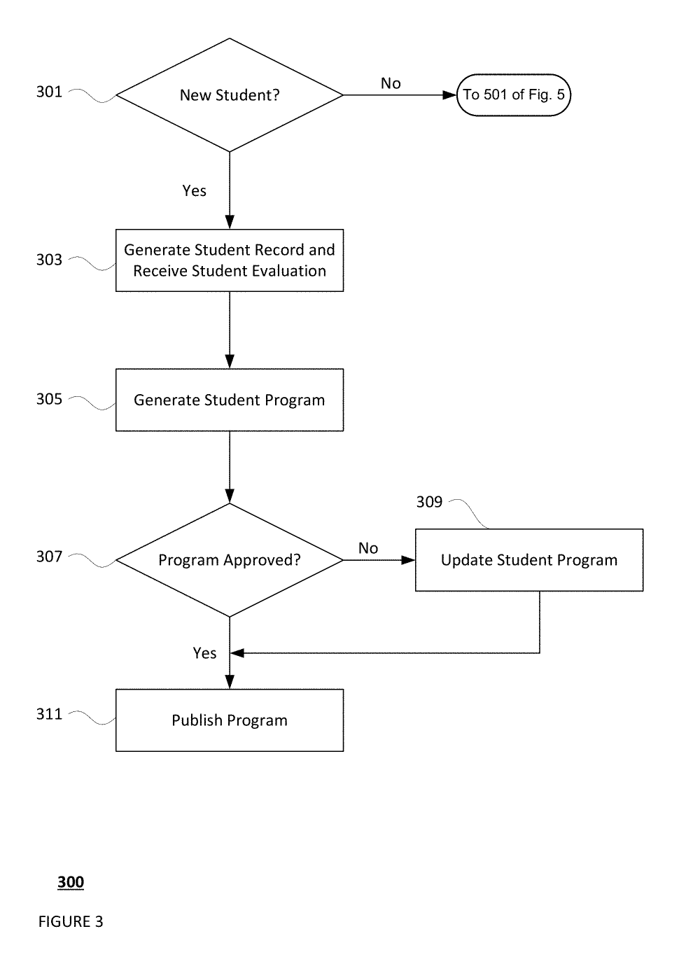

For purposes of highlighting features of the present invention, exemplary processes and interfaces for generating and monitoring one or more student programs shown in FIGS. 3-8, are described herein in connection with operations performed at components of the system 100, as described in FIGS. 1 and 2. It is to be understood that the some or all of the operations performed at the server computing device 110 may be performed at the educator computing device 120, and vice-versa.

In addition to the operations described above and illustrated in the figures, various operations will now be described. It should be understood that the following operations do not have to be performed in the precise order described below. Rather, various steps may be handled in a different order or simultaneously, and steps may also be added or omitted.

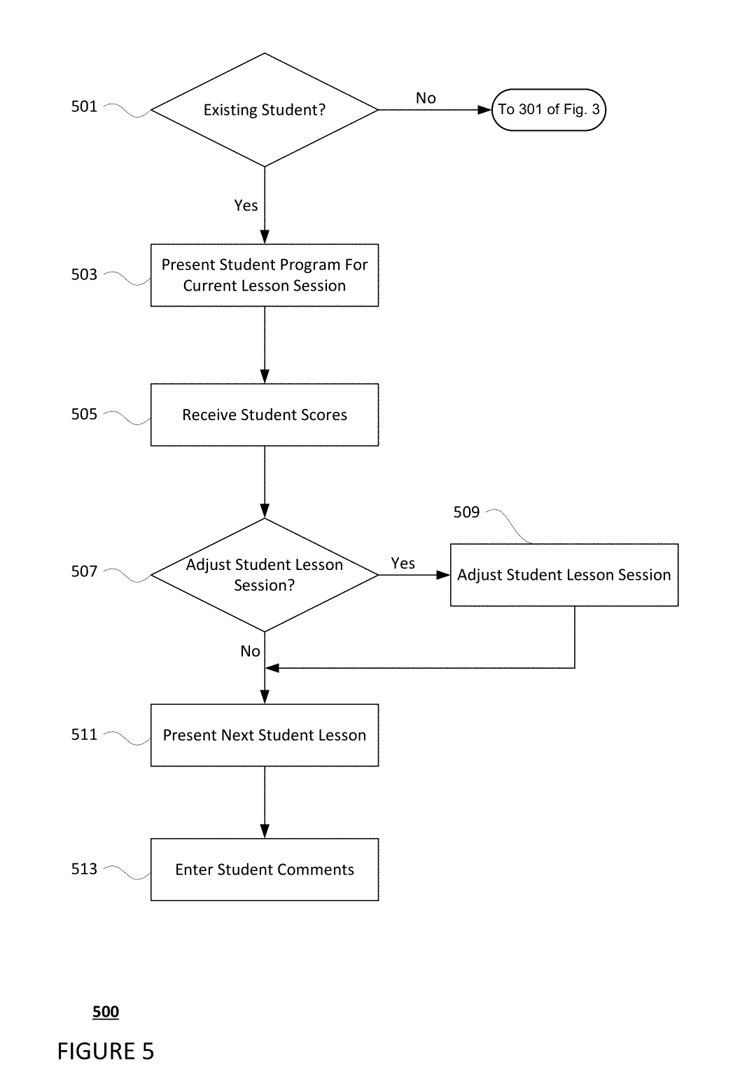

FIG. 3 is an example flow diagram 300 including a method for creating and managing a personalized student program using a computer device, such as educator computing device 120 executing the tracking program. Initially, a determination may be made by the computing device whether a student is a new student, as shown in block 301. In this regard, the educator computing device 120 may be configured to accept an input indicating that the student is new from an educator, or other such user, through a user device, such as user input device 124. Additionally, the educator computing device 120 may receive information regarding the potential student. The received information may be compared to the education data to determine if there is a record of the perspective student. In the event there is education data related to the perspective student, the student is not new. Upon determining the student is not new, the method may proceed to block 501, as shown in FIG. 5.

In the event the student is new, a new record may be created for the student as shown in block 303. The creation of a new record may include generating at least a portion of the student data as shown in Table 1.

Upon generating the new record, the student may be provided with a number of evaluation tasks, questions, and tests to determine a baseline of the student's knowledge and abilities. The results of the evaluation may be input into the educator computing device 120, as further shown in block 303. For example, a fourth grade student may be provided evaluation tasks, questions, and tests which cover material ascribed to a number of different grade levels, such as subjects and topics recommended for a second grader, third grader, fourth grade, fifth grader, and sixth grader. Such subjects and topics may include math, verbal, history, foreign languages and other such subjects and topics typically taught in schools.

The tracking program may analyze the student's data to generate a student program, as shown in block 305. In this regard, the educator computing device 120 may receive the results of an evaluation of the student's data and store them in association with the student's data. The student program may be automatically generated by the tracking program based on the student's results in view of the results of the evaluation. In this regard, based on the received results the tracking program may compare the student's knowledge and abilities against those of their peers to determine the student's strengths and weaknesses. Based on these strengths and weaknesses, the tracking program may generate a personalized student program which may help the student address weaknesses.

The generated student plan may be broken down into individual lesson sessions which may be completed by the student during a single instruction session with an educator. The generated student program may further include a schedule outlining the number of lesson sessions, number of hours per subject, dates of the lesson sessions, etc., which are required for the student to address their weaknesses. Further, the generated student program may be broken into lesson plans and/or lesson sessions by subjects, such as history, verbal, and math. Each subject may be scheduled as a portion, or all of, a lesson session.

The generated student program may include assigned material based on a set of rules. For instance, educators may have access to a set of material which has been evaluated by educators, who are trained to analyze and evaluate material, as being appropriate for students in certain grades and/or of certain abilities. Additionally, the trained educators may determine the set of materials may be most effective when used in conjunction with other materials As such, the tracking program may analyze the materials and plans in relation to a number of preprogrammed rules to assure that the materials and lesson plans which are assigned to the student satisfy the rules. For example, the rules may include determining whether the assigned material can be completed in the amount of time assigned to the student's lesson plan and whether the assigned material covers the subjects assigned to the student.

Upon generating the student program, the program may be presented for approval, as shown in block 307. In this regard, the tracking program may request final approval from the student's educator or other such individual operating the educator computing device 120. For instance, the tracking program may generate a display or audible alert indicating that approval of the generated student program is required, such as on the display 122 of the educator computing device 120, and requesting a response. Such an alert may be automatically created by the tracking program once the generated student program is created, and communicated over the network 160 from the server 110 to the device 120.

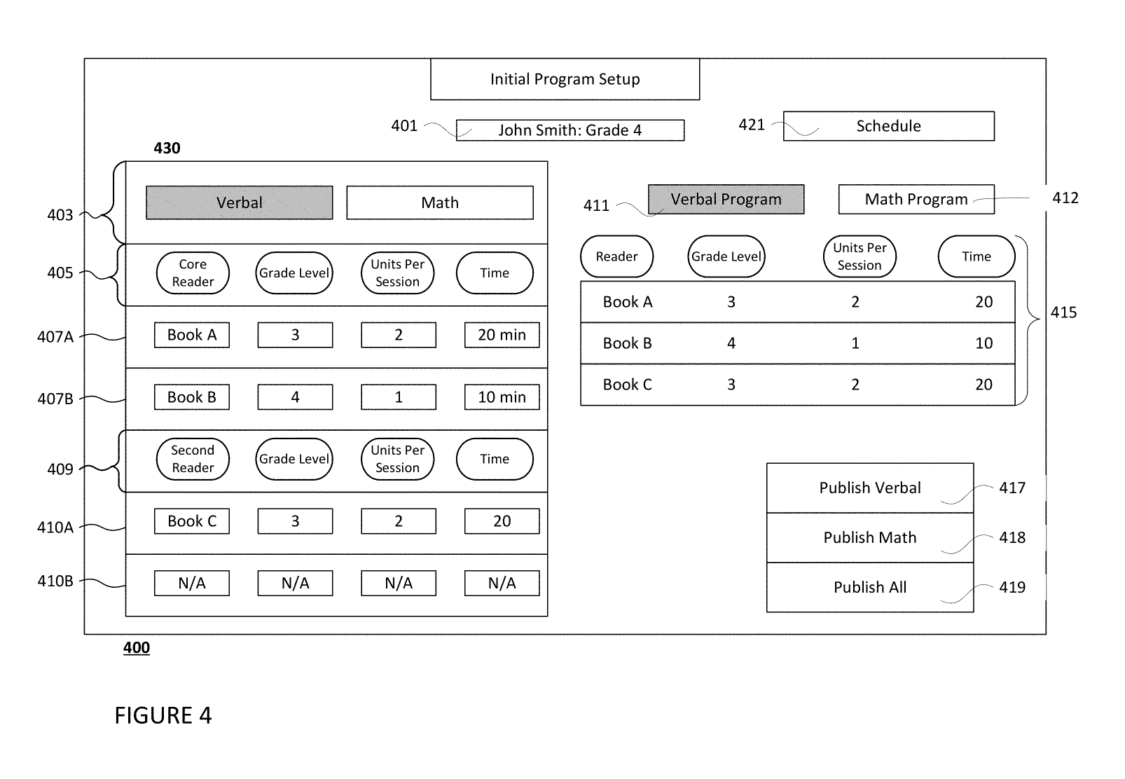

In the event the educator does not communicate a response, over the network 160 to the server, that approves the generated student program, the educator may manually edit the generated student program, as shown in block 309. In this regard, the educator may be presented an initial program setup interface 400 generated by the server 110 and communicated from the server 110 over the network 160 , as shown in FIG. 4. Through the initial program setup interface 400 the educator may change or accept the lesson sessions and materials for the student.

The initial program setup interface 400 may present the student's information 401, as well as subjects of the generated student program 415 and adjustment section 430. Referring to the subject section of the generated student program 415, the generated student program may be separated into subjects, such as the verbal program 411 and math program 412, although other subjects may also be included. The educator may switch between the subjects by selecting the button, or other input, associated with the subject of generated student program 415 which they wish to see. In the example interface shown in FIG. 4, the verbal program 411 may be selected and the corresponding verbal subject section, which is a portion of the generated student program, may be presented. The interface 400 may outline the material currently assigned in the generated student program (i.e., Book A, Book B, and Book C), the grade level assigned to the material, the number of units per session (i.e., the chapters, topics, etc., which may be scheduled per lesson session), and the time needed to complete the number of units.

The initial program setup interface 400 may also include an adjustment section 430. The adjustment section may allow the educator, or other user of the tracking program to adjust the generated student program. As shown in FIG. 4, the initial program setup interface may include a subject selection section 403, where an educator can select the subject he/she wants to adjust in the generated student program.

Based on the selected subject, the server 110 may generate a material overview section 405 and selectable primary materials 407A and 407B for presentation on the interface 400. Additionally, secondary material overview section 409 and selectable secondary materials 410A and 410B may also be presented. Although two primary materials and two secondary materials are presented, more or fewer materials may be presented. Similarly, more or fewer overview sections may be presented.

Each primary and secondary material may be associated with predetermined or adjustable details. For example, each primary and secondary material may be associated with a predetermined grade level. For example, Book A may be assigned grade level 3, which may be adjusted by trained educators. For each material selected by the educator, recommended units per session may be generated automatically by the server or entered manually. Additionally, the time for each primary and secondary session may be automatically updated by the server based on the units per session assigned to that piece of material or entered manually.

The material overview section 405 and secondary overview section 409 may outline the type of material selectable by the educator. For example, when the verbal subject is selected in the subject selection section 403, the material overview section 405 may provide an outline for core reader(s), which may be the primary book(s) assigned to a student. In another example, when the verbal subject is selected in the subject selection section 403, the secondary overview section 409 may provide an outline for secondary reader(s), which may be additional book(s) assigned to a student. In the event the subject selection section 403 is on math, the material overview section 405, as well as the secondary overview section 409 may be changed to display math type material selectable by the educator, such as primary and secondary math books. Additionally, the selectable primary and secondary materials may be changed to math material, such as geometry, calculus books, etc. Other subjects may be available in the subject selection section 403, and the material overview section 405 and secondary overview section 409 may be updated to correspond with subjects selected in the subject selection section 403. The material discussed herein may be based on the material approved by the trained educators and/or available at tutoring centers, as well as based on the results of the student's evaluation and subsequent results through the generated student program. Moreover, the educator may adjust the student's schedule by selecting box 421.

For each change made by the educator to the generated student program, the tracking program may analyze the change in relation to the preprogrammed rules to assure that the materials and lesson sessions assigned to the student satisfy the rules. Should the rules not be met, an alert may be generated by the server and communicated over the network 160 to be presented to the educator on the device 120. In some embodiments the educator may bypass the preprogrammed rules or ignore the alerts presented.

The educator, after adjusting the generated student program, or determining the generated student program is acceptable, may instruct the tracking program to publish the program as shown in block 311 of FIG. 3. In this regard, the generated student program may be finalized by storing the generated student program and its other associated data, such as the materials assigned, lesson sessions, schedule, etc., in association with the student, educator, and/or tutoring center. The generated student program may then be published, making it accessible to educators. The generated student program may be retrieved, modified, and/or deleted at a later time.

Referring again to FIG. 4 and the initial program setup interface 400, the educator may publish part of, or the entire generated student program. In this regard, to publish the entire generated student program, the educator may select the Publish All button 419. Should the educator wish to publish only one of the subject sections of the generated student program 415, they may select the Publish Verbal button 417 or Publish Math button 418. Although only math and verbal buttons are shown, publish buttons corresponding to other subjects may also be displayed.

Upon a student reporting for a lesson session, the tracking system may perform a number of tasks, as outlined in flow diagram 500 of FIG. 5. In this regard, the tracking system may determine if the student is an existing student as shown in block 501. In this regard, the student's name and other such information may be entered into the application to be compared to the education data to determine whether the student is registered. If the student is not registered, the tracking method may proceed as if the student is a new student, as outlined in FIG. 3, starting at block 301. In some embodiments the tracking system may present a list of all existing students. In the event the student is not on the list of existing students, the educator may initiate the new student process, as outlined in FIG. 3, starting at block 303.

Upon determining the student is registered, the educator may be presented with the student's program for the current lesson session, such as on the display of the educator computing device 120, as shown in block 503. The educator may have the student perform the lessons contained in the current lesson session, such as on the device 120, in the order in which the system presents them. As the student completes lessons during a lesson session, a tracking program may request the student to answer questions and/or take a test to track and determine the student's progress. In this regard, the device 120 or the server 110 may track the student's progress throughout the lesson session based on the results of the questions and the tests entered into the tracking program as shown in block 505.

Based on the student's progress the tracking program may update the student's program in real-time or alert the educator that an adjustment is necessary. For example, the tracking program may continually monitor all scores and answers input by the educator. The tracking system may refer to a plurality of monitoring rules to determine whether the current student session should be adjusted. Depending on whether or not the monitoring rules are met, an alert, such as a pop-up comment outlining the reason for the alert and a suggested change outlining how the alert may be remedied by changing the session lesson or generated student plan may be caused to be displayed on the device 120 by the server 110. The educator may then choose to accept the change or reject the change as shown in block 507. For example, the tracking program may monitor the answers and scores input by the educator to determine if the student has scored higher than a predetermined threshold score for a particular number of consecutive lessons. Upon determining the student has scored higher than the threshold score for a particular number of lessons the system may prompt the educator to skip a predetermined number of lessons. Examples of additional monitoring rules are presented in Table 2, below.

TABLE 2

| | | Comment | | | Suggestion | |
|---|---|---|---|---|---|---|
| Indication | Condition | displayed | Action on clicking accept | | displayed on page | |
| End of | Student will | Nearing | Move to next level of | | Resource name will | |
| resource | finish a | resource | resource at conclusion of | | move to the next | |
| | resource in | name | current resource. | | level at conclusion | |
| | his next | completion | (Automated update) | | of the current level. | |
| | session. | | | | (Automated update) | |
| 50-hour | Student is | Core | Replace current core | | Replace with next | |
| rule | within two | reader is | reader with the next core | | core reader at 50 | |
| | sessions of | within two | reader on list at 50 overall | | instructed hours | |
| | using this | sessions of | instructed hours. | | unless modified. | |
| | core reader | being used | | | (Automated update) | |
| | for 50 hours. | for 50 | | | | |
| | | hours. | | | | |
| Too hard | Less than | Low scores | | If the previous level | 1. | Resource name, |
| | 70% on three | on | | for the resource has | | level X, will be |
| | consecutive | resource | | never been assigned | | immediately |
| | lessons on | name | | for the student, | | replaced by |
| | the same | | | immediately replace | | level x-1. |
| | level of a | | | current level with the | 2. | Resource name |
| | resource. | | | previous level. | | to be temporary |
| | | | | If the previous level | | replaced by new |
| | | | | has been used, place | | resource for the |
| | | | | the resource on hold | | next 25 |
| | | | | and replace with the | | instructed |
| | | | | next resource listed for | | hours. |
| | | | | that subject, (i.e., | 3. | Resource name |
| | | | | Replace the resource | | will be |
| | | | | with the next one on | | immediately |
| | | | | the list. Put original | | replaced by new |
| | | | | resource on the | | resource. |
| | | | | pending list to replace | | |
| | | | | the resource that | | |
| | | | | replaced it in 25 hours | | |
| | | | | or when the core | | |
| | | | | reader moves to the | | |
| | | | | next level, whichever | | |
| | | | | comes first.) | | |
| | | | | If the previous level | | |
| | | | | has been used, and the | | |
| | | | | resource has been put | | |
| | | | | on hold, replace with | | |
| | | | | the next suggested | | |
| | | | | resource. | | |
| Too easy | Five | Perfect | Immediately assign the | | All resources will | |
| | consecutive | scores on | next level for all non-skill | | be moved up a | |
| | sessions with | full | based resources. | | level. | |
| | an overall | program | | | | |
| | score of | | | | | |
| | 100% | | | | | |
| Too few | Student | Finishing | Immediately increase by | | Additional reader | |
| | completed | program | one the number of units | | resources will | |
| | additional | early | assigned for all additional | | increase the number | |
| | work after | | readers resources. | | of units per session | |
| | completing | | | | by one. | |
| | program | | | | | |
| | during the | | | | | |
| | last three | | | | | |
| | consecutive | | | | | |
| | sessions. | | | | | |
| Too much | Student did | Not | Immediately decrease by | | Additional reader | |
| | not complete | completing | one the number of units | | resources will | |
| | program for | program | assigned for all additional | | decrease the | |
| | two of the | | reader resources. | | number of units per | |
| | last four | | | | session by one. | |
| | consecutive | | | | | |
| | sessions. | | | | | |
| End of | Student is | Nearing | At end of subject hours to | | 1. | New resource |
| Subject | within two | subject | the following depending | | | name will |
| | sessions of | name | on subject: | | | replace Visual |
| | completing | completion | 1. | Visual Perception or | | Perception/ |
| | his time in a | | | Vocabulary - replace | | Vocabulary |
| | subject. | | | subject resources with | | once all Visual |
| | | | | one Additional Reader | | Perception/ |
| | | | | piece | | Vocabulary |
| | | | 2. | Phonics - replace with | | hours have been |
| | | | | two Additional Reader | | used. |
| | | | | pieces | 2. | New resource |
| | | | 3. | Writing - If Study | | name one and |
| | | | | Skills is prescribed, | | new resource |
| | | | | replace with study | | name two will |
| | | | | skills program. | | replace Phonics |
| | | | | Otherwise replace | | once all Phonics |
| | | | | with two Additional | | hours have been |
| | | | | Readers | | used. |
| | | | 4. | Study Skills - If | 3. | The Huntington |
| | | | | writing is prescribed, | | Study Skills |
| | | | | replace with writing | | Program or |
| | | | | program. Otherwise | | resource names |
| | | | | replace with two | | will replace |
| | | | | Additional Readers | | writing. |
| | | | 5. | Math - remove math | 4. | The Huntington |
| | | | | program. | | Writing |
| | | | | | | Program or |
| | | | | | | resource names |
| | | | | | | will replace |
| | | | | | | study skills. |
| | | | | | 5. | Math is |
| | | | | | | completed and |
| | | | | | | removed from |
| | | | | | | the program. |

| | | | | |
|---|---|---|---|---|
| Above | Student's | Core reader | When the current level of | New core reader |
| Level | core reader | above | the core reader is finished, | will replace current |
| | grade level is | ending | replace with the next core | core reader at the |
| | one grade | grade level | reader on the list at the | end of the current |
| | above his | | current grade level. | level. |
| | ending grade | | | |
| | level (EGL) | | | |
| Above | Student's | Additional | At the end of the current | New resource |
| Level | additional | reader | level, replace with the | replaces current |
| | reader grade | above | next resource listing | resource once |
| | level is one | ending | starting one grade level | completed. |
| | grade above | grade level | below the level of the core | |
| | his ending | | reader | |
| | grade level | | | |
| | (EGL) | | | |
| Math, | Less than | Student is | Set the move on flag for | Notify teacher to |
| stuck in | 90% in the | unable to | the current sub-skill. | move on to the next |
| sub-skill | same sub- | progress | | sub-skill. |
| | skill for three | past sub- | | |
| | consecutive | skill | | |
| | sessions | | | |
| Core | Core reader | Core | Increase the level of the | Increase grade level |
| reader gap | is more than | reader | core reader by one. | of core reader |
| | two grade | name is | | name by one. |
| | levels below | more than | | |
| | the grade | two grades | | |
| | level of two | lower than | | |
| | or more | the | | |
| | additional | student's | | |
| | reading | additional | | |
| | resources | reading. | | |

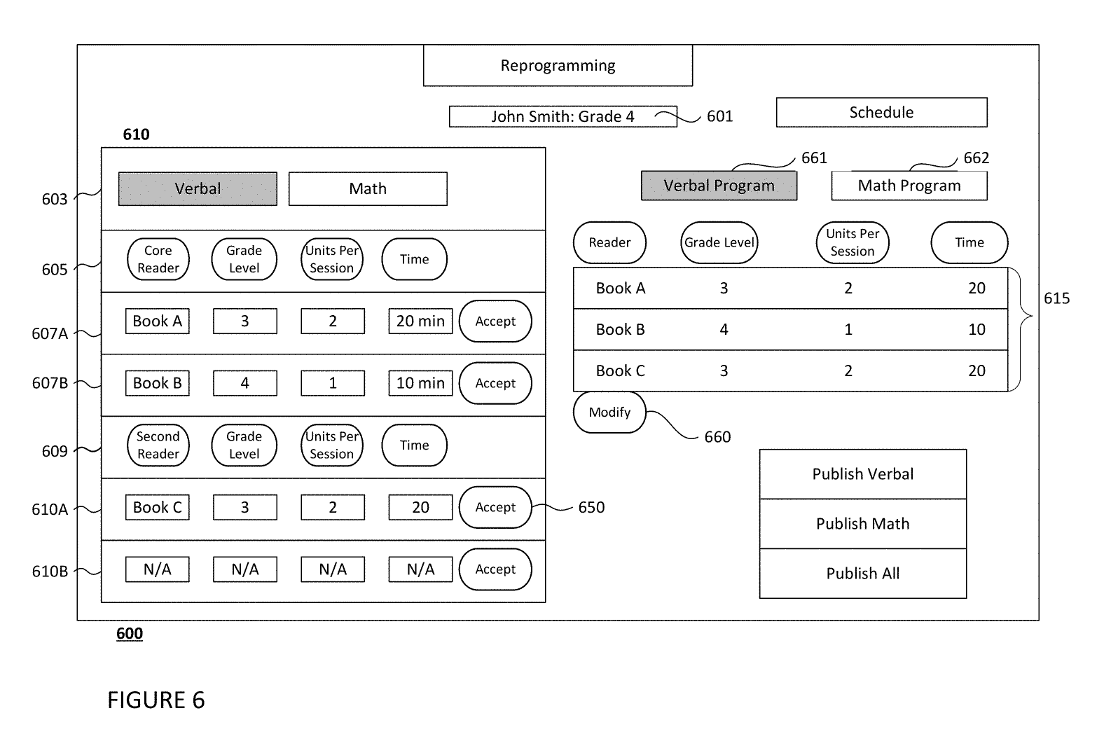

Upon the educator choosing to adjust the current student lesson session based on the comments displayed by the tracking program, the educator may adjust the lesson session and/or generated student program, as shown in block 509. In this regard, the educator may adjust the current lesson session or the overall generated student program using a reprogramming interface 600, as shown in FIG. 6.

The reprogramming interface 600 may be similar to the initial program setup screen, and generated at and provided by the server 110 for display at the device 120. In this regard, the reprogramming interface may include the student's information 601, as well as subjects of the generated student program 615 and adjustment section 610. In the reprogramming interface the educator may modify the previously assigned material in the subjects section 615 of the reprogramming interface 600. For example, the educator may select subject buttons 661 or 662 to load the verbal lesson session or math lesson session, respectively. The educator may then select the modify button 660 to adjust the material within the selected session. In this regard, the educator may be given the option to delete material, adjust the number of unit or time per session, and/or reorder the material.

Additionally, the educator may select new material from the adjustment section. As with the initial program setup interface, the adjustment section 610 may allow the educator, or other user of the tracking program, to adjust the generated student program. For instance, the educator may select a subject from the subject selection section 603, such as verbal or math. Based on the selected subject, a material overview section 605 and selectable primary materials 607A and 607B may be presented. Additionally, secondary material overview section 609 and selectable secondary materials 610A and 610B may also be presented. Although two primary materials and two secondary materials are presented, more or fewer materials may be presented. Similarly, more or fewer overview sections may be presented.

The educator may select primary or secondary materials to add to the generated student program 615. In this regard, after setting the adjustable details (e.g., units per session, time, etc.) the educator may select the accept button 650 to add the primary or secondary materials to the generated student program. The educator, after adjusting the generated student program, or determining the generated student program is acceptable, may instruct the tracking program to publish the generated student program, as described with regard to the initial program setup interface 300.

Referring again to FIG. 5, upon publishing the updated generated student program, the next student lesson may be presented to the educator, as shown in block 511. In some embodiments the educator may reject any changes to the generated student program, as such the reprogramming interface 600 may not be presented to the educator and the next student lesson may be presented.

During, or at the completion of a lesson session, the educator may enter notes and/or comments regarding the student or the generated student program into the tracking program. Such comments and notes may be caused by the server 110 to be displayed automatically to an educator at the device 120 upon the educator accessing the student's generated student program. In some embodiments the comments and notes will be displayed as soon as the student's lesson session is started, or at a predetermined time before or after the start of the student lesson session.

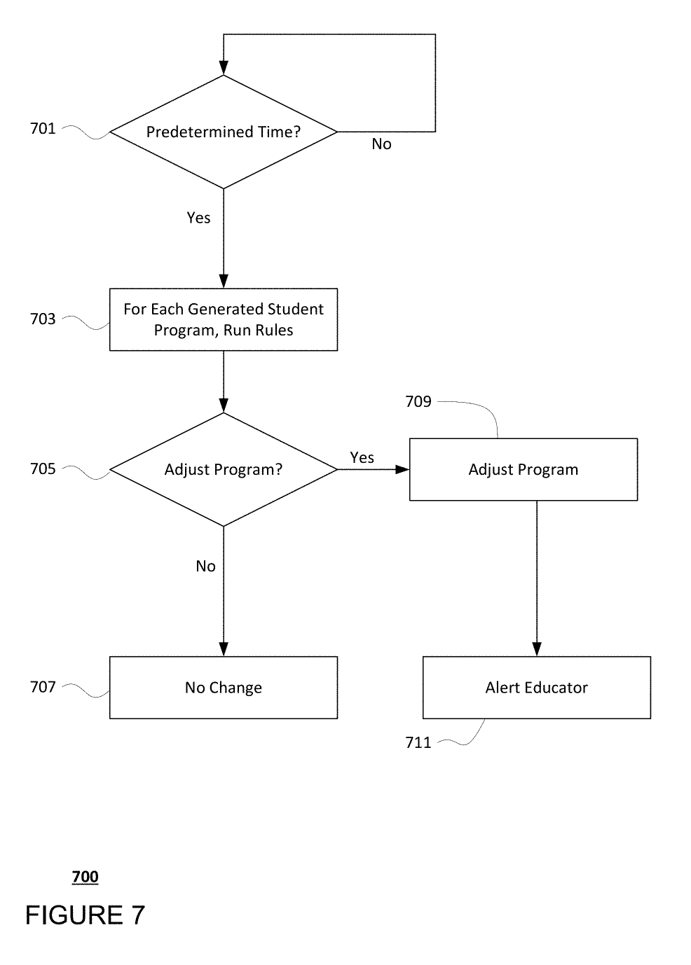

The tracking program may analyze each generated student program for compliance with a set of rules at preset intervals, as shown in flow 700 of FIG. 7. In this regard, the tracking program may continually monitor the time to determine whether a predetermined time or time period has occurred, such as once a day at 3 am, or 24 hours after a previous predetermined time occurring, as shown in block 701. In the event the predetermined time has not occurred, the program may continue to monitor the time.

Upon the predetermined time occurring, each generated student program may refer to a plurality of rules to determine whether the generated student program complies with the rules, as shown in block 703. The rules may be the rules as shown in Table 2. Based on the results of the determination with reference to the rules the program may determine whether to automatically adjust the student program or alert the educator that a change to a generated student program may be necessary, as shown in block 705. Should the program not need to be adjusted, no changes will be made, as shown in block 707.

In the event one or more student generated programs need to be adjusted, the program may automatically adjust the program, as shown in block 709. In this regard, the student generated programs which need to be adjusted may be placed into compliance with the rules. In some embodiments the adjustments may not occur automatically. Rather, the recommended adjustments may be presented to the educator of the student whose generated student program needs adjustments as shown in block 711.

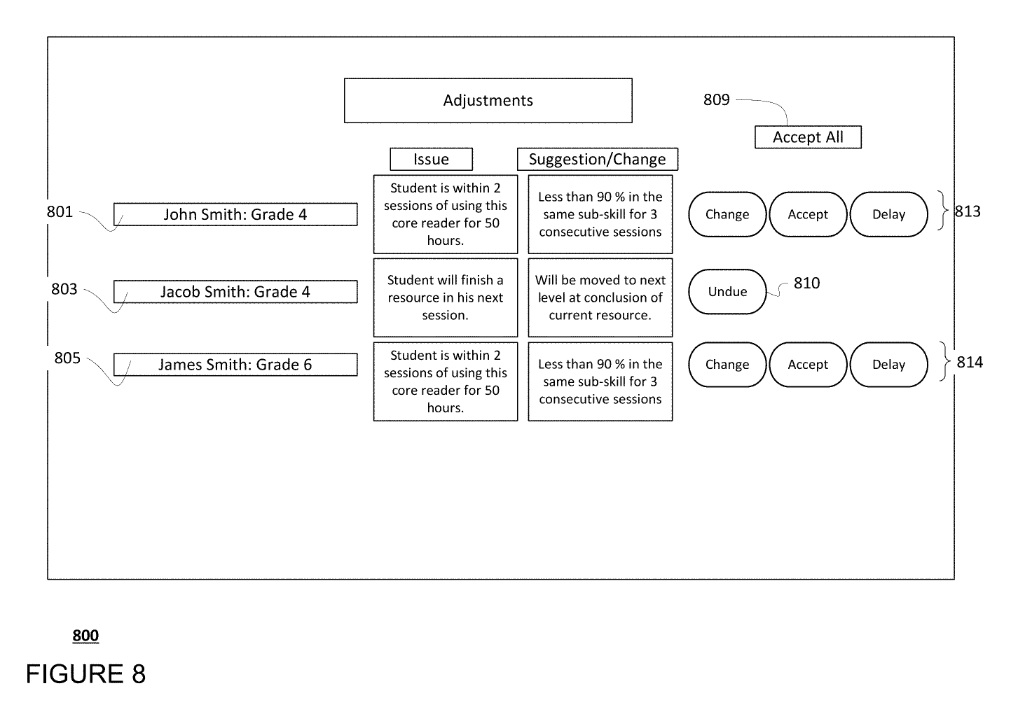

As shown in FIG. 8, the adjustment alerts may be generated by the server 110 and caused to be presented to the educator in an adjustment interface 800 at the device 120. The adjustment alerts may inform the educator of automatic changes, or may allow the educator to accept, reject, or delay recommended adjustments and undue automatic changes. For example, students 801 and 803 may have suggestions for correcting issues with their respective generated student programs. The educator may select one of buttons 813 or 814, based on whether the change should be accepted, changed, rejected, or delayed. Student 803 may have had an automatic change made to his/her generated student program. As such, the educator may be presented with the issue and change which was made. Should the educator wish to cancel the change, he/she may select the undue button 810. Alternatively, the educator may select the “accept all” button 809 to accept all recommended changes and not undo the automatic changes.

Unless otherwise stated, the foregoing alternative examples are not mutually exclusive, but may be implemented in various combinations to achieve unique advantages. As these and other variations and combinations of the features discussed above may be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings may identify the same or similar elements.

1. A computer implemented method for generating and monitoring one or more student programs, the method comprising:
loading, with one or more processors, education data corresponding to one or more students;
generating, for each student, with the one or more processors, a generated student program;
identifying, by the one or more processors, one or more generated student programs which fail to satisfy at least one or more rules; and
automatically reporting, by the one or more processors, the one or more generated student programs which fail to satisfy the at least one or more rules.

2. The computer implemented method of claim 1 further comprising:
tracking, for each student, with the one or more processors, the student's progress through the respective generated student program; and
identifying, by the one or more processors, the one or more generated student programs which fail to satisfy the at least one or more rules based on the student's progress; and
automatically reporting, by the one or more processors, the one or more generated student programs which fail to satisfy the at least one or more rules based on the student's progress.

3. The computer implemented method of claim 1 further comprising:
for each of the one or more generated student programs which fail to satisfy the at least one or more rules, updating the generated student program; and
determining that each updated student program satisfies all of the one or more rules; and
publishing the updated student programs.

4. The computer implemented method of claim 1 further comprising:
publishing, for each student, the generated student program.

5. The computer implemented method of claim 1, wherein identifying the one or more generated student programs which fail to satisfy the at least one or more rules occurs at a predetermined time period.

6. The computer implemented method of claim 1, wherein automatically reporting the one or more generated student programs which fail to satisfy the at least one or more rules comprises providing, with the one or more processors, a visual notification to a display.

7. A system for generating and monitoring one or more student programs, the system comprising:
one or more computing devices; and
memory storing instructions, the instructions executable by the one or more computing devices;
wherein the instructions comprise:
loading education data corresponding to one or more students;
generating, for each student, a generated student program;
identifying one or more generated student programs which fail to satisfy at least one or more rules; and
automatically reporting the one or more generated student programs which fail to satisfy the at least one or more rules.

8. The system of claim 7 further comprising:
tracking, for each student, the student's progress through the respective generated student program; and
identifying, the one or more generated student programs which fail to satisfy the at least one or more rules based on the student's progress; and
automatically reporting, the one or more generated student programs which fail to satisfy the at least one or more rules based on the student's progress.

9. The system of claim 7 further comprising:
for each of the one or more generated student programs which fail to satisfy the at least one or more rules, updating the generated student program; and
determining that each updated student program satisfies all of the one or more rules; and
publishing the updated student programs.

10. The system of claim 7 further comprising:
publishing, for each student, the generated student program.

11. The system of claim 7, wherein identifying the one or more generated student programs which fail to satisfy the at least one or more rules occurs at a predetermined time period.

12. The system of claim 7, wherein automatically reporting the one or more generated student programs which fail to satisfy the at least one or more rules comprises providing a visual notification to a display.

13. A non-transitory computer-readable medium storing instructions that, when executed by one or more processors, cause the one or more processors to perform the steps of:
loading education data corresponding to one or more students;
generating, for each student, a generated student program;
identifying one or more generated student programs which fail to satisfy at least one or more rules; and
automatically reporting the one or more generated student programs which fail to satisfy the at least one or more rules.

14. The non-transitory computer-readable medium of claim 13, further comprising:
tracking, for each student, the student's progress through the respective generated student program; and
identifying the one or more generated student programs which fail to satisfy the at least one or more rules based on the student's progress; and
automatically reporting the one or more generated student programs which fail to satisfy the at least one or more rules based on the student's progress.

15. The non-transitory computer-readable medium of claim 13, further comprising:
for each of the one or more generated student programs which fail to satisfy the at least one or more rules, updating the generated student program; and
determining that each updated student program satisfies all of the one or more rules; and
publishing the updated student programs.

16. The non-transitory computer-readable medium of claim 13, further comprising:
publishing, for each student, the generated student program.

17. The non-transitory computer-readable medium of claim 13, wherein identifying the one or more generated student programs which fail to satisfy the at least one or more rules occurs at a predetermined time period.

18. The non-transitory computer-readable medium of claim 13, wherein automatically reporting the one or more generated student programs which fail to satisfy the at least one or more rules comprises providing a visual notification to a display.
